(19) United States
(12) Patent Application Publication
(10) Pub. No.: US 2026/0227499 A1
(43) Pub. Date: Aug. 6, 2026

(54) RADAR SYSTEM AND METHOD FOR CALCULATING A POSITION OF A TRANSPONDER

(71) Applicant: FURUNO ELECTRIC CO., LTD., Nishinomiya-City (JP)

(72) Inventor: Masayuki SHIROMOTO, Nishinomiya (JP)

(73) Assignee: FURUNO ELECTRIC CO., LTD., Nishinomiya-City (JP)

(21) Appl. No.: 19/578,958

(22) Filed: Mar. 26, 2026

Related U.S. Application Data
(63) Continuation of application No. PCT/JP2023/035309, filed on Sep. 27, 2023.

(51) Int. Cl. G01S 13/08; G01S 7/04; G01S 7/14; G01S 13/76; G01S 13/87; G01S 13/88

(52) U.S. Cl. CPC G01S 13/08; G01S 7/043; G01S 7/14; G01S 13/767; G01S 13/87; G01S 13/88

(57) ABSTRACT

A radar system for calculating a position of a transponder is disclosed. A transmitter generates an electromagnetic signal. An antenna transmits and receives the electromagnetic signal. A circulator connects the antenna with the transmitter. A distress signal receiver receives signals from one or more target objects in response to the transmitted electromagnetic signal, and filters a distress signal, representing twelve bright points on the radar screen with adjacent bright points being separated by a fixed distance, at one or more frequency bands received from the transponder through the antenna. Processing circuitry, operatively connected to the transmitter and the distress signal receiver, controls at least one operation of one of the transmitter and the distress signal receiver, and calculates an actual distance of the transponder.

### CROSS-REFERENCE TO RELATED APPLICATION(S)

This application is a bypass continuation of International Application No. PCT/JP2023/035309, filed on Sep. 27, 2023. The entire contents of the above application are incorporated herein by reference.

### TECHNICAL FIELD

The present disclosure generally relates to object detection techniques and, more particularly, to a Radio Detection and Ranging (RADAR/radar) apparatus (or a radar system) and a method for calculating a position of a transponder during an emergency situation to rescue a distress vessel in a marine environment.

### BACKGROUND

Moving bodies in the marine environment such as vessels, ships, barges, boats, etc. are typically used for the transportation of people and goods among other various applications, across the globe. Apparatuses used in the detection, ranging, and monitoring, such as RAdio Detecting and Ranging (RADAR) and Sound Navigation and Ranging (SONAR) systems, are installed onboard moving bodies or stationary monitoring stations to identify other moving and stationary objects in the marine environment. These apparatuses transmit electromagnetic waves (in a radar) or sound pressure waves (in a sonar), sweeping the marine environment for other objects or bodies. The electromagnetic or sound pressure waves are then reflected from a target object, for example, a target ship or a vessel. The reflected electromagnetic or sound pressure waves received by the aforementioned apparatuses are called echoes. The echoes are generally considered signals carrying information about the distance, speed, direction, location, heading, etc. of the target object. Using the echo information, the concerned apparatuses, such as a radar or a sonar, can determine the location, direction, translational speed, etc., of the target object. The location of the target object may further be displayed with an echo trail on a display screen.

A Search And Rescue Transponder (SART) is an electronic device that transmits a distress signal to vessels in its immediate vicinity, in response to the detection of waves, for example, electromagnetic waves from a radar. The SARTs are made of waterproof components which protect them against damage by water. The SARTs are battery-operated and can operate for a long time in ships, lifeboats, and liferafts. In an emergency situation, a SART can be activated. The SART waits to receive the electromagnetic or sound pressure waves emitted from the detection, ranging, and monitoring apparatuses. SARTs are designed to remain afloat on the water for a long time in case the distress vessel is submerged in water. Upon receiving the electromagnetic or sound pressure waves from an apparatus (e.g., RADAR, SONAR), the SART sends a distress signal to the apparatus. The distress signal, also known as a distress call, is displayed on the radar screen as twelve bright points (also referred to as SART echoes), and is an internationally recognized means for obtaining help. Distress signals are communicated by transmitting radio signals, displaying a visually observable item or illumination, or making a sound audible from a distance. The distress signal can also be received by the radar and the position of the SART can be displayed on the radar screen.

FIG. 1 represents a rescue system 100 used to rescue a distress vessel 102, in accordance with the conventional art. The distress vessel 102 has a transponder (e.g., SART 106), and a radar system 108 is used to detect the distress signal. An example of the radar system 108 is a RADAR-SART. The RADAR-SART transmits electromagnetic waves 110 around the rescue vessel. Such waves 110 are detected by the SART 106 and in response to such detection, the SART 106 transmits a distress signal in the form of twelve pulses (e.g., SART echoes 112) having the same frequency as the electromagnetic waves 110. The twelve pulses are displayed on the radar screen as a series of twelve points with a gap of about 0.6 NM [Nautical Miles] between them. The radar system 108 receives the distress signal (i.e. twelve points), processes the distress signal, and displays the position of SART 106 on the radar screen. The first point generally represents the position of the SART 106, while the other points are in a straight line toward the edge of the radar screen.

A SART forms a part of the Global Maritime Distress and Safety System (GMDSS) for locating ships in distress. The GMDSS is an internationally recognized distress and radio communication safety system that has been in place for several decades. The GMDSS is an automated ship-to-shore and ship-to-ship system using satellites and/or terrestrial radio systems with digital selective calling technology.

However, systems and methods in the state of the art, for displaying the position of the SART and the SART echoes (e.g., 12 points), suffer from several deficiencies. For instance, it is difficult to accurately detect the position of the SART and with such detections, the signal processing load becomes relatively high. In that regard, several solutions have been suggested to at least partially address the aforementioned deficiencies. Some of the proposed solutions have been listed below.

In one document, a conventional radar is disclosed in which search data in the distance direction is determined by transmitting/receiving a pulse radio wave in a specified direction and start timing of a response signal is detected by cross-correlation processing of the search data and a signal of constant period substantially equal to that of a response signal delivered from a radar transponder. A mark on a radar screen indicative of the position of the radar transponder is displayed, along with radar echo, at a position on a radar screen corresponding to the start timing.

Another document discloses a conventional signal processing device and method to accurately detect a distress signal from a SART and reduce a calculation load for the detection. The device includes an instantaneous frequency change rate calculator 802 configured to calculate a change rate of an instantaneous frequency of a complex reception signal generated from a reception wave received by a wave receiver. A memory (storage) is configured to store a value obtained based on a reference frequency sweep rate that is a frequency sweeping speed of the distress signal. A distress signal determiner is configured to determine whether the distress signal is issued from the SART, based on a comparison result between the instantaneous frequency change rate calculated by the instantaneous frequency change rate calculator and the value obtained based on the reference frequency sweep rate stored in the memory.

FIG. 2A represents the display output 202 on the radar screen showing the twelve points 204 of the distress signal received from the SART. The radar antenna receives the twelve points 204 of the distress signal based on the reception bands set in the distress signal receiver of the radar system. The display output 202 is obtained when the SART is located away (for example, >2 NM) from the radar system. The radar range is set as 10 NM and the rings on the screen are 2 NM apart. When the SART and the radar system are away, then the echoes (e.g., twelve points 204) are displayed on the radar screen. The display output 212 shown in FIG. 2B on the radar screen is obtained when the SART is located close (1 NM) to the radar system. The radar range is set as 10 NM and the rings on the screen are 2 NM apart. When the SART and the radar system are close, then the radar screen shows that the echoes (e.g., twelve points) expand (e.g., arch 214) in the azimuth direction as shown in FIG. 2B.

The display output 222 shown in FIG. 2C is obtained on the radar screen, when the SART is located near (for example, >0.2 NM) to the radar system. The radar range is set as 10 NM. When the SART is very close to the radar system, the radar screen shows that the twelve points expand in azimuth and form concentric circles 224, as shown in FIG. 2C. When the SART is too close, the SART echoes are displayed as concentric circles 224, and thus locating the exact SART position is difficult.

FIG. 3 represents echoes (in the form of arch 302) from a position 304 of the SART. When the vessel is in distress, the SART can be activated from the distress vessel. A position 306 of the rescue vessel and position 304 of the SART are shown in FIG. 3. The echoes received from the SART are in the form of twelve points and are expanded (e.g., arch 302) in the azimuth (e.g., angle A) as shown in FIG. 3. In such a situation, in conventional art systems, it is difficult to locate the position of the SART in the azimuth, as the echoes are in the form of concentric circles superimposing on the SART position, thereby obscuring the position of the SART.

Therefore, there exists a need for techniques to provide the exact location of the SART in the azimuth direction when the SART is very near or close to the radar system, in addition to providing other technical advantages.

### SUMMARY

An advantage of various embodiments is to provide a Radio Detection and Ranging (RADAR) apparatus (a radar system) for calculating a position of a transponder. The radar system includes a transmitter configured to generate an electromagnetic signal; an antenna 516 configured to transmit and receive the electromagnetic signal; a circulator 542 configured to connect the antenna 516 with the transmitter for transmitting the electromagnetic signal and to connect the antenna 516 with a distress signal receiver for receiving a distress signal; a distress signal receiver configured to filter the distress signal at one or more frequency bands; and processing circuitry 536 including a controller 600 and a transponder distance detector, where the transponder distance detector is configured to calculate an actual distance of the transponder. The radar system may further include a display configured to display, on a radar screen, the position of the transponder determined by the processing circuitry.

In an aspect, the transponder distance detector includes an instantaneous frequency change rate calculator and a distress signal determiner. The instantaneous frequency change rate calculator is configured to calculate a change rate of an instantaneous frequency of the signals received from one or more target objects. The distress signal determiner is configured to detect the distress signal from the transponder by comparing the change rate of the instantaneous frequency of the signals received from one or more target objects with a reference frequency sweep rate of the distress signal.

In an aspect, the transponder distance detector includes a memory. The memory is configured to store at least the reference frequency sweep rate of the distress signal, the distance of each bright point, an azimuth of each bright point, and a signal level (amplitude) of each bright point, upon detecting the distress signal from the transponder by the transponder distance detector.

In an aspect, the distress signal determiner of the transponder distance detector is further configured to receive at least one transmission frequency from the transmitter and the one or more frequency bands from the distress signal receiver, calculate a transponder deviation value between the position of the transponder and the first bright point of twelve bright points and calculate the actual distance of the transponder using the one or more frequency bands of the distress signal receiver and the calculated transponder deviation value.

In an aspect, the processing circuitry further includes a transponder azimuth detector. The transponder azimuth detector is configured to obtain azimuth information where the signal level of each bright point becomes a peak in the azimuth direction at a given distance, based on the distance, azimuth, and signal level of each bright point stored in the memory, to similarly obtain azimuth information of all bright points from the peak value of each bright point, and to calculate the azimuth of the transponder based on the averaged value of the obtained azimuth information of all bright points or the most frequently occurring azimuth information.

In an aspect, the processing circuitry further includes a transponder position calculator. The transponder position calculator is configured to obtain the actual distance of the transponder obtained from the transponder distance detector, obtain the azimuth of the transponder from the transponder azimuth detector, and calculate a latitude and longitude of the transponder based at least on the latitude and longitude of the vessel, the actual distance of the transponder, and the azimuth of the transponder.

In an aspect, the radar system further includes a user interface. The user interface is configured to accept a setting of at least an Electronic Bearing Line (EBL) representing an azimuth from the vessel to the transponder and a Variable Range Marker (VRM) representing the actual distance from the vessel to the transponder.

In an aspect, the display is configured to display the latitude and longitude of the transponder along with a marking, on the radar screen.

In yet another aspect, a method or a non-transitory computer-readable medium (CRM) having stored thereon computer-executable instructions which, when executed by processing circuitry, cause the processing circuitry to execute processing for calculating a position of a transponder, using a Radio Detection and Ranging (RADAR) apparatus is disclosed. The method or the CRM includes determining, by a transponder position detector, the position of the transponder. Determining the transponder position detector includes the steps of generating, by a transmitter, an electromagnetic signal, connecting, by a circulator, an antenna with the transmitter for transmitting the electromagnetic signal around a vessel, and connecting, by the circulator, the antenna with a distress signal receiver for receiving a distress signal from the transponder. The steps further include filtering, by the distress signal receiver, in response to the transmitted electromagnetic signal, a distress signal at one or more frequency bands received from the transponder through the antenna. The distress signal represents twelve bright points on the radar screen and the adjacent bright points are separated by a fixed distance. The steps further include operatively connecting, by the controller, the transmitter and the distress signal receiver, and controlling at least one operation of one of the transmitter and the distress signal receiver. The steps further include calculating, by processing circuitry including a transponder distance detector, an actual distance of the transponder by operatively connecting the controller and the transponder distance detector. The method or the program may further include displaying, by a display, on a radar screen, the position of the transponder determined by the transponder position detector.

The foregoing summary is illustrative only and is not intended to be in any way limiting. In addition to the illustrative aspects, embodiments, and features described above, further aspects, embodiments, and features will become apparent by reference to the drawings and the following detailed description.

The Radio Detection and Ranging (RADAR) apparatus for calculating a position of a transponder is disclosed. The radar system installed in a vessel (for example, a rescue vessel) transmits the electromagnetic waves around the vessel. A transponder (e.g., SART) in or near a distress vessel (in an emergency and in need of rescue), in response to detecting the electromagnetic waves, transmits a distress signal at the same frequency as the electromagnetic waves. The distress signal received from the transponder is displayed as twelve bright points (also referred to as “SART echoes”) on the radar screen. The amount of deviation between the transponder position and the first bright point is calculated from the distance of the first bright point of the transponder signal and the information of the radar reception band.

A transponder distance detector calculates an actual distance of the transponder and obtains a distance, an azimuth, and a signal level of each bright point, upon detecting the distress signal from the transponder. A transponder azimuth detector calculates the azimuth of the transponder based on the distance, the azimuth, and the signal level of each bright point. A transponder position calculator is configured to calculate the latitude and longitude of the transponder based at least on the latitude and longitude of the vessel, the actual distance, and the azimuth of the transponder. The present disclosure provides an exact location (with a marking on the radar screen) of the transponder (e.g., SART) in the azimuth when the transponder is very near or close to the radar system.

### BRIEF DESCRIPTION OF DRAWINGS

The following detailed description of illustrative embodiments is better understood when read in conjunction with the appended drawings. For the purpose of illustrating the present disclosure, exemplary constructions of the disclosure are shown in the drawings. However, the present disclosure is not limited to a specific device, or a tool and instrumentalities disclosed herein. Moreover, those skilled in the art will understand that the drawings are not to scale.

FIG. 1 illustrates a simplified block diagram of a rescue system used in a marine environment, in accordance with the conventional art;

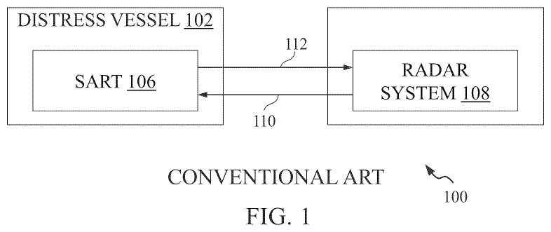

FIGS. 2A-2C illustrate display outputs on a radar screen showing a distress signal received from a transponder, in accordance with the conventional art;

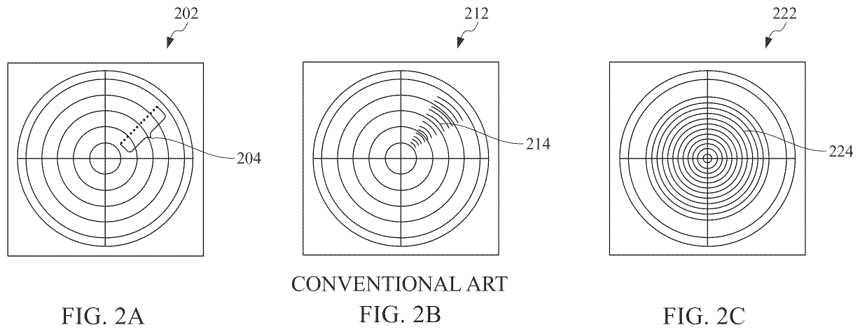

FIG. 3 illustrates a display output on the radar screen in the azimuth direction showing the position of the transponder, rescue vessel, and distress vessel position, in accordance with the conventional art;

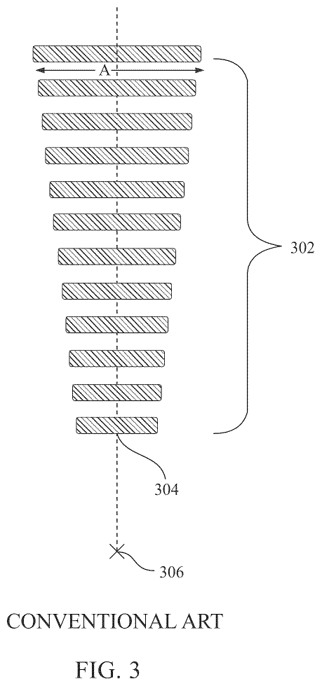

FIG. 4 illustrates an example representation of an environment related to at least some example embodiments of the present disclosure;

FIG. 5 illustrates a simplified block diagram of the sensing apparatus, such as a radar or a sonar, in accordance with an embodiment of the present disclosure;

FIG. 6 illustrates a simplified block diagram of processing circuitry of the sensing apparatus, such as a radar or a sonar, in accordance with an embodiment of the present disclosure;

FIG. 7 illustrates a schematic diagram showing an example display output of the sensing apparatus using a Variable Range Marker (VRM) and an Electronic Bearing Line (EBL), in accordance with an embodiment of the present disclosure;

FIG. 8 illustrates a simplified block diagram of a transponder distance detector of the sensing apparatus, in accordance with an embodiment of the present disclosure;

FIG. 9 shows views illustrating timings for a distress signal of the transponder and radar reception signal, in accordance with an embodiment of the present disclosure;

FIG. 10 illustrates a beam pattern of an antenna of the sensing apparatus, in accordance with an embodiment of the present disclosure;

FIG. 11 illustrates a representation of a peak value of each bright point in transponder echoes at the same distance, in accordance with an embodiment of the present disclosure;

FIG. 12 illustrates a representation of display output on the radar screen indicating the actual position of the transponder by using the EBL and the VRM, in accordance with an embodiment of the present disclosure;

FIG. 13 illustrates a flow diagram of a method for detecting and calculating the actual position of the transponder, in accordance with an embodiment of the present disclosure;

FIG. 14 illustrates a flow diagram of a method for detecting a distress signal from the transponder, in accordance with an embodiment of the present disclosure;

FIG. 15 illustrates a flow diagram of a method for calculating the actual distance of the transponder, in accordance with an embodiment of the present disclosure;

FIG. 16 illustrates a flow diagram of a method for calculating an azimuth of the transponder, in accordance with an embodiment of the present disclosure; and

FIG. 17 illustrates a flow diagram of a method for calculating the actual position of the transponder based on the azimuth information, in accordance with an embodiment of the present disclosure.

The drawings referred to in this description are not to be understood as being drawn to scale except if specifically noted, and such drawings are only exemplary in nature.

### DESCRIPTION OF EMBODIMENTS

In the following description, for purposes of explanation, numerous specific details are set forth in order to provide a thorough understanding of the present disclosure. It will be apparent, however, to one skilled in the art that the present disclosure can be practiced without these specific details. Descriptions of well-known components and processing techniques are omitted so as to not unnecessarily obscure the embodiments herein.

The examples used herein are intended merely to facilitate an understanding of ways in which the embodiments herein may be practiced and to further enable those of skill in the art to practice the embodiments described herein. Accordingly, the examples should not be construed as limiting the scope of the embodiments herein.

Reference in this specification to “one embodiment” or “an embodiment” means that a particular feature, structure, or characteristic described in connection with the embodiment is included in at least one embodiment of the present disclosure. The appearances of the phrase “in an embodiment” in various places in the specification are not necessarily all referring to the same embodiment, nor are separate or alternative embodiments mutually exclusive of other embodiments.

Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

Various embodiments of the present disclosure provide an apparatus and a method for detecting and calculating the actual position of the transponder in a marine environment. A Radio Detection and Ranging (RADAR) apparatus for calculating a position of a transponder is disclosed. The radar system installed in a vessel (for example, a rescue vessel) transmits electromagnetic waves around the vessel. A transponder in or near a distress vessel (in an emergency and in need of rescue) in response to detecting the electromagnetic waves, transmits a distress signal having the same frequency as the electromagnetic waves. The distress signal received from the transponder is displayed as twelve bright points on the radar screen.

The radar system has a transponder distance detector configured to calculate an actual distance of the transponder and obtain a distance, an azimuth, and a signal level of each bright point, upon detecting the distress signal from the transponder. A transponder azimuth detector calculates the azimuth of the transponder based on the distance, the azimuth, and the signal level of each bright point. A transponder position calculator is configured to calculate a latitude and longitude of the transponder based at least on the latitude and longitude of the vessel, the actual distance, and the azimuth of the transponder.

The transponder position calculator uses a latitude and longitude of the rescue vessel obtained from a GPS satellite for calculating the latitude and longitude of the transponder. The transponder position calculator receives the actual distance of the transponder from the transponder distance detector and the azimuth of the transponder from the transponder azimuth detector, and uses the latitude and longitude of the rescue vessel for calculating the latitude and longitude of the transponder.

The transponder distance detector has a distress signal determiner. The distress signal determiner receives the transmission frequency from the transmitter and the one or more frequency bands from the distress signal receiver. The distress signal determiner calculates a transponder deviation value between the position of the transponder and the first bright point of twelve bright points. The actual distance of the transponder is calculated using the one or more frequency bands of the distress signal receiver and the calculated transponder deviation value.

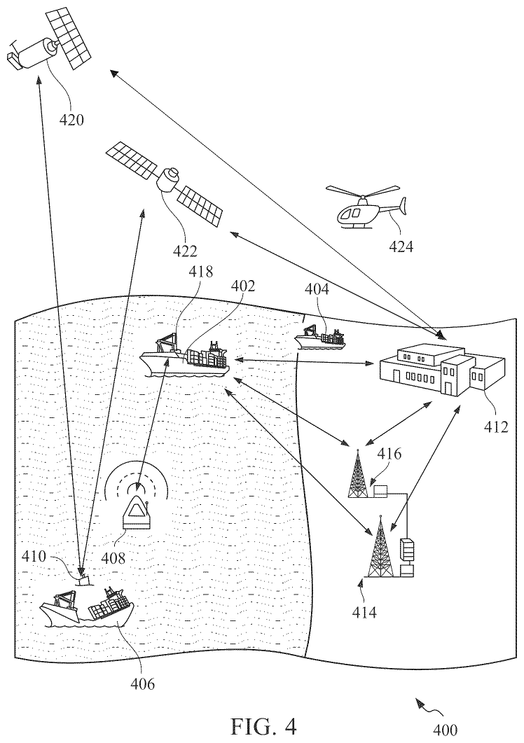

The present disclosure displays the actual distance of the transponder 408 from the rescue vessel, along with the latitude and longitude of the transponder on the radar screen. Various embodiments of the present disclosure are described hereinafter with reference to FIG. 4 to FIG. 17.

FIG. 4 illustrates an example representation of an environment 400 related to at least some example embodiments of the present disclosure. Environment 400 is for example, a marine environment comprising one or more watercraft (e.g., a vessel) configured to sail in water bodies (e.g., sea). Environment 400 includes one or more vessels 402, 404, and 406, a transponder 408 (e.g., SART 408), and an Emergency Position Indicating Radio Beacon (EPIRB) 410. The environment 400 also includes a rescue center 412, a communication base station 414, and a communication network station 416. The EPIRB 410 is a device used to alert Search And Rescue (SAR) services in case of an emergency arising at sea. The EPIRB 410 is tracking equipment that transmits a signal on a specified band to locate a lifeboat, liferaft, ship, or people in distress.

The vessel 406, also referred to as a distress vessel 406, is under an emergency and is about to submerge fully in the sea. The transponder 408 is activated, for example, by a crew member of the distress vessel 406 upon identifying the existing emergency or upcoming emergency. Upon activation, the transponder 408 is capable of detecting signals (e.g., electromagnetic or pressure signals) from the RADAR or SONAR apparatuses, in one or more vessels. For example, a vessel 402, also referred to as a rescue vessel 402, is installed with at least one radar system 418. The radar system 418 is used to identify one or more objects in the environment 400. The radar system 418 may include one or more components configured to detect target objects (either in the static or dynamic state) present within a predetermined display range of the rescue vessel 402 (acting as the observation station) and determine one or more parameters associated with the detected target objects. One or more parameters associated with the detected target objects are not limited to position information, traveling information, direction, and velocity. Such information is displayed on the radar screen. The observer can view the radar screen and understand the potential threats around the own vessel.

The radar system 418 transmits a plurality of electromagnetic waves through several full-circle (360-degree) sweeps. The plurality of electromagnetic waves reach the one or more target objects (e.g., one or more vessels 404, and 406, the transponder 408, the EPIRB 410, etc.) and are reflected from one or more target objects. The reflected waves corresponding to the plurality of electromagnetic waves, referred to as echoes are received by the vessel 402.

In an emergency situation, the transponder 408 waits for such plurality of electromagnetic waves transmitted from, for example, the radar system 418 of the rescue vessel 402. The transponder 408 upon detecting the plurality of electromagnetic waves, transmits a distress signal to the radar system 418 of the rescue vessel 402. The distress signal will be in the form of twelve echo signals, that appear as twelve points on the radar screen. Based on the received distress signal, the rescue vessel 402 identifies the location of the distress vessel to perform rescue operations.

In one embodiment of the disclosure, the EPIRB 410 can be activated either manually (by pressing a button) or automatically (when it floats freely from the distress vessel 406). In a distress situation, the EPIRB 410 can be set off (activated). Once set off, the EPIRB 410 transmits a coded message to satellites (e.g., a GPS satellite 420) indicating the emergency situation of the distress vessel 406. The GPS satellite 420 may then signal the rescue center 412 to perform rescue operations. In one embodiment of the disclosure, the rescue center 412 identifies the nearby vessel, (e.g., the rescue vessel 402) and instructs to immediately reach the distress vessel 406 to perform rescue operations. In some embodiments, the EPIRB 410 may communicate with a rescue satellite 422 which in turn communicates with the rescue center 412. The rescue center 412 then performs necessary rescue operations.

The one or more vessels 402, 404, and 406 may be associated with the communication base station 414 and the communication network station 416. The communication base station 414 and the communication network station 416 can be communicably coupled to the rescue vessel 402 through wireless communication. It should be noted that the rescue center 412 through the communication network station 416 connects with one or more vessels, devices, and systems in the marine environment 400.

The communication base station 414 serves as a central connection point for wireless devices to communicate. The communication base station 414 has a fixed transceiver and acts as a main communication point for one or more moving objects (e.g., vessel 402, and an aircraft 424), stationary objects (e.g., vessel 404), and other systems (not shown) in the marine environment 400. The communication base station 414 can have one or more receive/transmit antenna, microwave dish, electronic circuitry, etc., used to handle traffic, such as cellular traffic, data traffic, signal traffic, etc. It serves as a bridge between the communication devices, and systems in the marine environment 400, such as one or more moving objects (e.g., vessel 402, and an aircraft 424), stationary objects (e.g., vessel 404), and other systems (not shown).

The communication network station 416 connects the communication devices, and systems in the marine environment 400. In marine environment 400, the communication devices, and systems are installed in but not limited to one or more moving objects (e.g., vessels 402, 406, and an aircraft 424), stationary objects (e.g., a vessel 404), and other systems (not shown). In one embodiment, the communication devices, and systems in the marine environment 400 include apparatuses used in the detection, ranging, and monitoring, such as RADAR and SONAR systems, installed onboard the moving bodies or stationary monitoring stations. The communication usually happens through wireless means, such as a radio channel in telecommunications and computer networking. The communication network station 416 is used for information transfer of, for example, a digital bit stream, from one or several senders to one or several receivers. The communication network station 416 has a certain capacity for transmitting information, often measured by its bandwidth in Hz or its data rate in bits per second.

The radar system 418 and other communication devices and systems in the marine environment 400 communicate with each other and also with the communication base station 414 using the communication network station 416. In some embodiments, the communication network station 416 acts as a Dual Function RADAR communication Base Station (DFBS). In the DFBS system, the communication base station 414 functions both as the central connection point for the wireless device to communicate and also acts as radar system 418, for example, a radar to receive echo signals reflected from the targets.

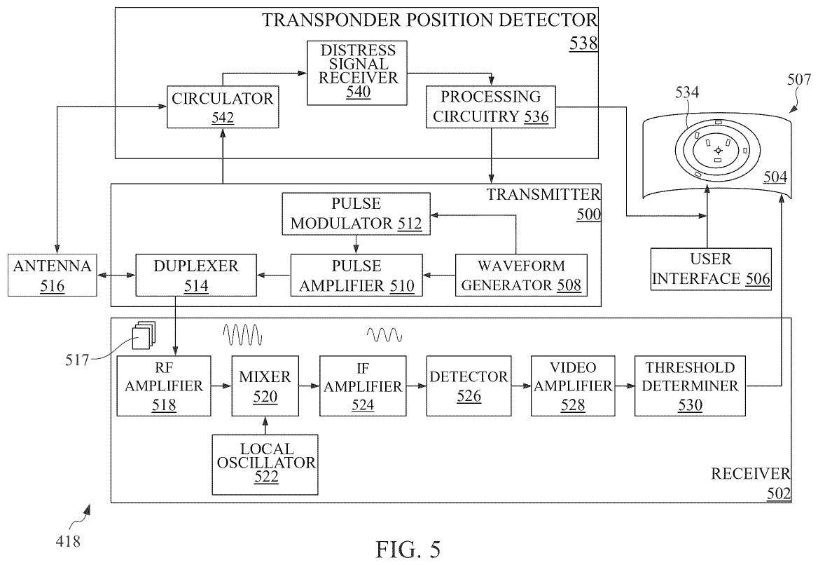

FIG. 5 illustrates a simplified block diagram of the sensing apparatus (e.g., a radar system 418), in accordance with an embodiment of the present disclosure. The radar system 418 has a transmitter 500, a receiver (an ordinary receiver on a conventional radar) 502, a radar screen 504, and a User Interface (UI) 506. The radar system 418 also may have a display 507 configured to display the twelve points representing distress signals, the position of the rescue vessel 402, etc. on the radar screen 504. The transmitter 500 can be one of, but not limited to a magnetron, a traveling wave tube, or a transistor amplifier.

The transmitter 500 has a waveform generator 508 for generating a low-power source signal (e.g., radio waves or source waves). The source waves (e.g., electromagnetic waves) are transmitted from the observation station (e.g., the vessel 402) for detecting a target object, (e.g., one or more vessels 404, and 406, the transponder 408, the EPIRB 410, etc.). The signal generated by the waveform generator 508 is fed to a pulse amplifier 510. In the case of a pulse radar, magnetrons are widely used as transmitters but whenever there exists a need for high average power then the pulse amplifier 510 can be used.

The transmitter 500 also has a pulse modulator 512. The pulse modulator 512 turns ON and OFF the pulse amplifier 510, according to the input pulses generated by the waveform generator 508. A duplexer 514 is used to form isolation between the transmitter 500 and the receiver 502. The transmission of the source waves by the transmitter 500 and reception of echo by the receiver 502 can be done using a single antenna 516, as shown in FIG. 5. The duplexer 514 allows the use of the single antenna 516 for both transmission and reception purposes. As the transmitter 500 and the receiver 502 operate at different power levels, the duplexer 514 isolates the transmitter 500 and the receiver 502. Thus, the signal from the pulse amplifier 510 is provided to the antenna 516 through the duplexer 514.

The antenna 516 also receives echoes from the one or more target objects. Information that can be extracted from echoes, referred to as echo information 517, may include locations, directions, and speeds of the one or more target objects. Using the echo information 517, the location, direction, and speed of the target object can be calculated by the radar system 418.

An example of the receiver 502 is a superheterodyne receiver. The superheterodyne receiver is a type of radio receiver that uses frequency mixing to convert the echo to a fixed Intermediate Frequency (IF) signal which can be more conveniently processed than the original carrier frequency. The receiver 502 has a Radio Frequency (RF) amplifier 518 (e.g., low noise RF amplifier). The RF amplifier 518 acts as the input stage for the receiver 502. The RF amplifier 518 generates an RF pulse which is proportional to the echo of the source waves. In one embodiment, the RF amplifier 518 acts at the input stage of the receiver 502. In another embodiment, a mixer 520 acts at the input stage by eliminating the RF amplifier 518. The mixer 520 mixes the output of the RF amplifier 518 and the output of a local oscillator 522 and the output of the mixer 520 is fed into an IF amplifier 524. In IF amplifier 524, the RF pulse received from the mixer 520 is converted into an IF signal. The IF signal generated by the mixer 520 is amplified by the IF amplifier 524. The IF amplifier 524 acts as a matched filter and increases the Signal to Noise Ratio (SNR) of the echo. Also, it enhances the echo-detecting ability of the receiver 502 by reducing the effects of unwanted signals. The bandwidth of the receiver 502 is associated with the bandwidth of the IF amplifier 524.

The receiver 502 also has a detector 526 (e.g., a crystal diode) to perform demodulation of the echo by separating the source waves from a carrier. A video amplifier 528 amplifies the echo to a level that can be displayed on the radar screen 504. In one embodiment of the disclosure, the detector 526 and the video amplifier 528 are replaced with an analog-to-digital (A/D) converter. The analog-to-digital (A/D) converter performs digital signal processing of the IF signal. A threshold determiner 530 decides the existence of the target object in the marine environment 400. The threshold determiner 530 is set with a threshold value that is compared with the magnitude of the source waves. If the threshold value is surpassed by the threshold determiner 530, then this shows the presence of the target object. Otherwise, it is assumed that only the noise component is present in waves received by the antenna 516.

The radar screen 504 shows a display output 534 of the receiver 502. The range and location of the target object are displayed on the radar screen 504, by mapping it in polar coordinates. In one embodiment, the radar screen 504 is implemented with a Plan Position Indicator (PPI) implemented with Cathode Ray Tube (CRT). The display output 534 modulates the electron beam of the CRT to permit the electron beam to sweep from the center in the outward direction of the CRT. The sweep represents a rotation in synchronization with the pointing of the antenna 516.

The antenna 516 acts as a transceiver for transmitting source waves around the vessel 402. The antenna 516 also receives the echo from the target object. A radar system 418 processes the received echo and sends the echo information 517 (e.g., location, direction, speed of target object), to the radar screen 504 in the form of echo images. The radar system 418 also has the UI 506 for allowing a user to input display parameters. In one embodiment, the UI 506 allows the user to change the display parameters, such as display range (e.g., 12 NM, 3 NM, 1.5 NM, where NM represents Nautical Miles), pulse width (e.g., pulse width of the size, small, large, medium), etc. of the radar screen 504.

The radar system 418 is configured to locate the target objects present within the predetermined area of the vessel 402 based on receipt of the reflected source waves (e.g., echo) being intercepted by the target vessels. Moreover, the radar system 418 is configured to determine the coordinates of the target vessels and the distance between the vessel 402 and each of the target vessels. The distance between the vessel 402 and the target vessels is computed based on the time measured between the transmission of the source waves and receipt of the echo. From the received echo, echo information 517 such as locations, directions, and speeds of the one or more target objects can be extracted by the radar system 418.

The distress signal is emitted by the transponder 408 upon detecting the electromagnetic waves from the radar system 418. The distress signal emitted by the transponder 408 is at the same frequency as the detected electromagnetic waves from the radar system 418. The radar system 418 processes the distress signal and displays it in the form of twelve points on the radar screen 504.

It should be noted that the distress signal can be received using the antenna 516 but processing of the distress signal can be performed using separate processing circuitry (e.g., transponder processing circuitry 536). In some embodiments, the existing receiver 502 can be configured to cooperate with, or share front-end circuitry with, the distress signal receiver 540 to receive the distress signal from the transponder 408. In such embodiments, the processing circuitry (e.g., transponder processing circuitry 536) can be incorporated into the existing processing circuitry of the radar system 418 to process the distress signal and to display the twelve points on the radar screen 504. It should be noted that the term “transponder processing circuitry” 536 can be interchangeably used as “processing circuitry” 536, “processing unit” 536, etc.

In FIG. 5, a separate module (e.g., transponder position detector 538) is configured to receive the distress signal from the transponder 408 via the antenna 516. A circulator 542 is configured to connect the antenna 516 with the transmitter 500 for transmitting the electromagnetic signal around the vessel 402. In response to the transmitted electromagnetic signal, a distress signal receiver 540 is configured to filter the distress signal at one or more frequency bands received from the transponder 408 through the antenna 516, by configuring the circulator 542 to connect the antenna 516 to the distress signal receiver 540.

The transponder processing circuitry 536 is operatively connected to the transmitter 500 and the distress signal receiver 540 and configured to control at least one of the transmitter 500 and the distress signal receiver 540. The transponder processing circuitry 536 is configured to calculate an actual distance of the transponder 408 and display the actual distance of the transponder 408 along with the distress signal in the form of twelve equally spaced points (dots) on the radar screen 504.

The user interface 506 is configured to accept a setting (from observer or user) of at least an Electronic Bearing Line (EBL) representing an azimuth from the vessel 402 to the transponder 408 and a Variable Range Marker (VRM) representing the actual distance from the vessel 402 to the transponder 408. The latitude and longitude of the transponder 408 along with a marking on the radar screen 504 are displayed, by the display 507, on the radar screen 504.

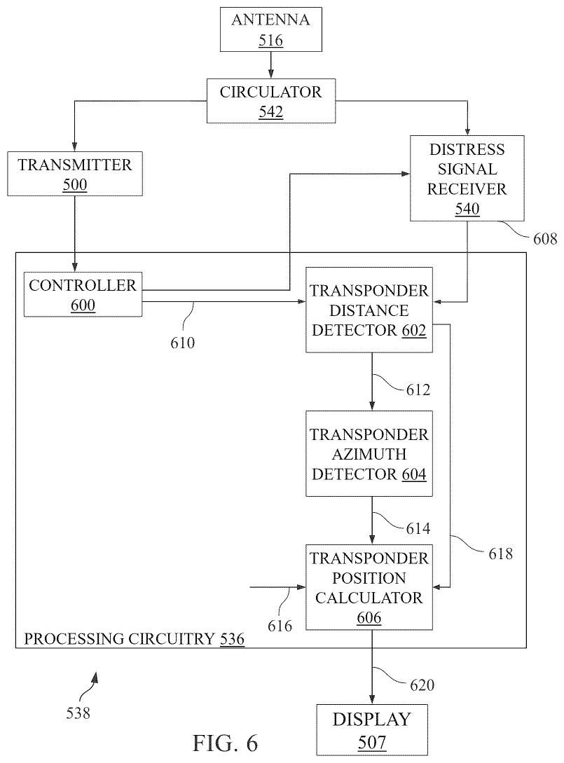

FIG. 6 illustrates a simplified block diagram of the transponder processing circuitry 536 of the radar system 418, in accordance with an embodiment of the present disclosure. The radar system 418 calculates the actual position of the transponder 408 and displays the same on the radar screen 504 by indicating the actual position of the transponder 408. In the azimuth, when the rescue vessel 402 is close to the transponder 408, the actual location of the transponder 408 is difficult to identify. The present disclosure marks the actual position of the transponder 408 on the radar screen, thereby the observer can easily see the location of the transponder 408 even in the azimuth.

The transponder position detector 538 is configured to determine the actual position of the transponder 408. The transmitter 500 is configured to generate an electromagnetic signal. The circulator 542 is configured to connect the antenna 516 with the transmitter 500 for transmitting the electromagnetic signal around the vessel 402. In response to the transmitted electromagnetic signal, the distress signal receiver 540 is configured to filter the distress signal received from the transponder 408 at one or more frequency bands through, the antenna 516. The circulator 542 is configured to connect the antenna 516 to the distress signal receiver 540. The distress signal generally includes twelve bright points (also referred to as twelve points) separated by a fixed distance. The distress signal along with the position of the transponder 408 is displayed on the radar screen 504, so that the rescue vessel 402 can quickly react to the emergency situation.

The processing circuitry 536 has a controller 600. The controller 600 is operatively connected to the transmitter 500 and the distress signal receiver 540 and configured to control at least one operation of the transmitter 500 or the distress signal receiver 540. The transmitter 500 is configured to transmit the electromagnetic waves from the rescue vessel 402 via the antenna 516. The at least one operation of the distress signal receiver 540 is a reception of distress signal 608 from the transponder 408 via antenna 516.

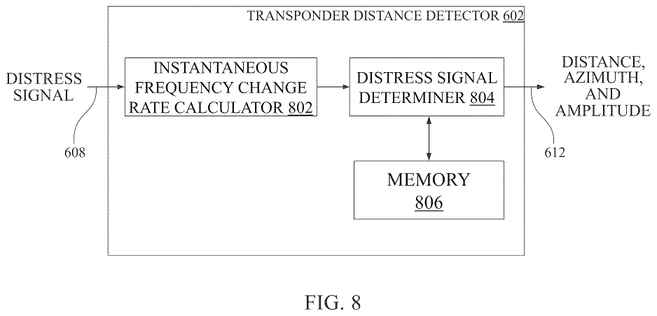

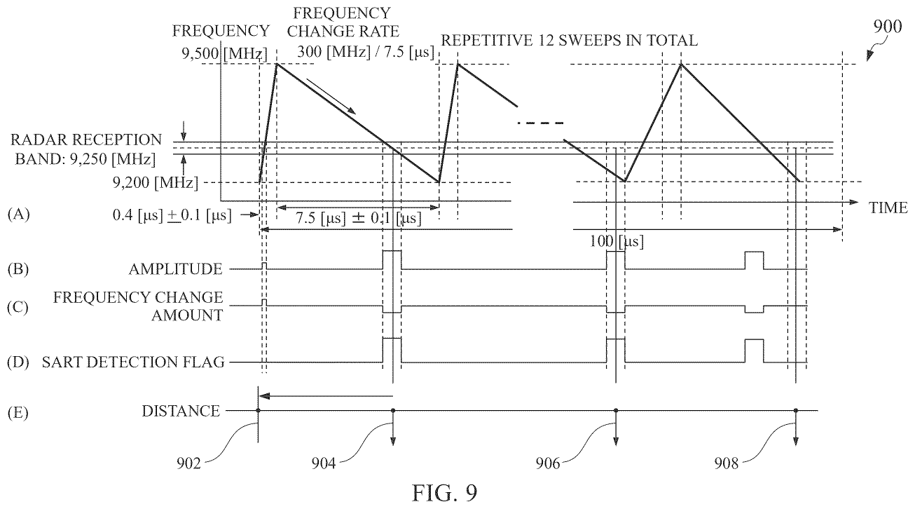

The processing circuitry 536 has a transponder distance detector 602, a transponder azimuth detector 604, and a transponder position calculator 606. The transponder distance detector 602 is operatively connected to the controller 600 and is configured to generate distance/azimuth/signal-level information 612 (e.g., distance, azimuth, and signal level [amplitude] of each bright point) for the transponder 408, and to calculate the actual distance 620 of the transponder 408. The radar screen 504 is configured to display the position of the transponder 408 determined by the transponder position detector 538. In order to calculate the actual position of the transponder 408, the transponder distance detector 602 receives the distress signal 608 from the distress signal receiver 540 and information 610 (e.g., transmission frequency and radar reception band) from the controller 600. The controller 600 can obtain the transmission frequency and radar reception band from transmitter 500. The transponder distance detector 602 processes the distress signal 608, the transmission frequency, and the radar reception band (referred to as information 610) and calculates the actual distance 620 of the transponder 408 based on the distress signal 608 and the information 610. The transponder distance detector 602 is further configured to store at least the distance of each bright point (i.e. the distress signal), an azimuth of each bright point, and a signal level of each bright point, when the distress signal is detected by the transponder distance detector. The processes of calculating the actual position of the transponder 408 are explained in FIGS. 8 and 9.

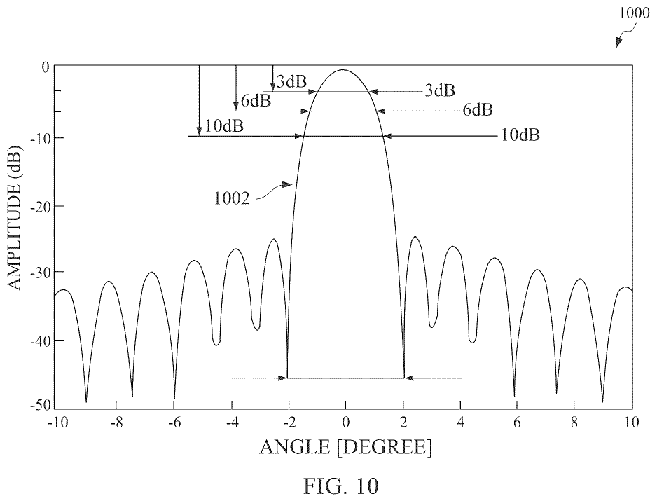

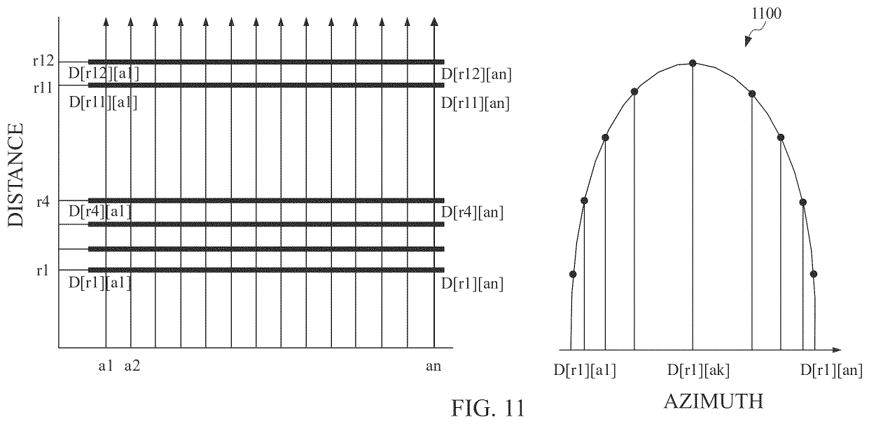

The processing circuitry 536 also has a transponder azimuth detector 604. The transponder azimuth detector 604 retrieves information 612, for example, the distance of each bright point (i.e. the distress signal), the azimuth of each bright point, and the signal level of each bright point, from a memory of the transponder distance detector 602. The transponder azimuth detector 604 processes the distance of each bright point (i.e. the distress signal), the azimuth of each bright point, and the signal level of each bright point and calculates the azimuth of the transponder 408. The processes of detecting the azimuth of the transponder 408 are explained in FIGS. 10 and 11.

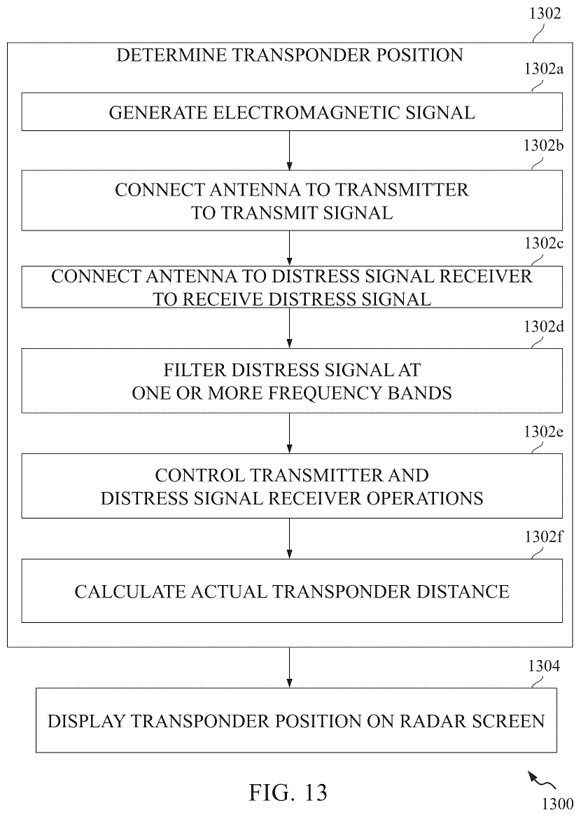

The processing circuitry 536 also has a transponder position calculator 606. The transponder position calculator 606 receives the azimuth information 614 of the transponder 408 from the transponder azimuth detector 604, retrieves a Latitude and longitude information 616 (from the GPS satellite 420) of the rescue vessel 402, and distance information 618 from the memory of the transponder distance detector 602. The transponder position calculator 606 processes the azimuth information 614 of the transponder 408, distance information 618 of the transponder 408, and the latitude and longitude information 616 of the rescue vessel 402, and calculates a position (e.g., latitude and longitude) of the transponder 408. The processes of calculating the actual position of the transponder 408 are explained in FIG. 13. The display 507 is configured to display the actual distance 620 of the transponder 408 on the radar screen 504.

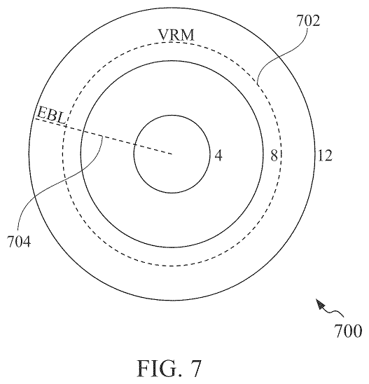

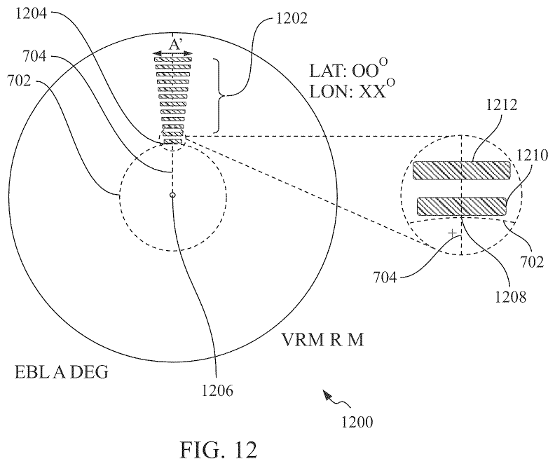

FIG. 7 illustrates a schematic diagram showing an example display output 700 of the radar system 418 using a Variable Range Marker (VRM) 702 and an Electronic Bearing Line (EBL) 704, in accordance with an embodiment of the present disclosure. As shown in FIG. 7, the processing circuitry 536 is configured to detect the distance and azimuth of the transponder 408 from the received distress signal, and the detected distance and azimuth are displayed on the radar screen 504. In some embodiments, the detected distance and azimuth are displayed along with EBL 704 or VRM 702 are displayed on the radar screen 504. On the radar screen 504, the VRM 702 appears as a circle that is centered on the current location of the vessel 402, and the EBL 704 appears as a line that begins at the current location of the rescue vessel 402 and intersects the VRM 702. When the latitude and longitude information of the rescue vessel 402 is known, the latitude and longitude of the transponder 408 can be calculated from the transponder 408 position (distance, azimuth) relative to the rescue vessel 402. The latitude, longitude, and distance between two points can be calculated as per display output shown in FIG. 7. The point of intersection of the VRM 702 and the EBL 704, represents the target object. A representation of a display output on the radar screen indicating the actual position of the transponder 408 by using the EBL 704 and the VRM 702, is shown in FIG. 12.

FIG. 8 illustrates a simplified block diagram of the transponder distance detector 602 of the radar system 418, in accordance with an embodiment of the present disclosure. The radar system 418 can receive signals (in the form of echoes) from one or more target objects (stationary vessel 404, distress vessel 406, transponder 408, EPIRB 410), in response to the electromagnetic signal transmitted from the radar system 418. The transponder distance detector 602 has an instantaneous frequency change rate calculator 802 configured to receive signals (including distress signal) from one or more target objects and calculate a change rate of an instantaneous frequency of the received signals. A distress signal determiner 804 detects the distress signal from the transponder 408 by comparing the change rate of the instantaneous frequency of the received signals with a reference frequency sweep rate of the distress signal. If the change rate of the instantaneous frequency of the received signal is within a threshold of the reference rate of the distress signal, the distress signal determiner 804 determines that the received signal is the distress signal from the transponder 408.

A memory 806 is configured to store a reference frequency sweep rate of the distress signal. This can be obtained based on a minimum internationally accepted value of the reference rate of the distress signal transmitted by the transponder 408. When the distress signal is detected by the transponder distance detector 602, upon detecting the distress signal from the transponder 408, the distance of each bright point, an azimuth of each bright point, and a signal level of each bright point are stored in the memory 806, by the transponder distance detector 602. The information stored in the memory 806 can be further used by the transponder azimuth detector 604 and the transponder position calculator 606, to calculate the actual distance of the transponder 408.

In one embodiment of the disclosure, the distress signal determiner 804 receives the transmission frequency from the transmitter 500 and the one or more frequency bands from the distress signal receiver 540. A transponder deviation value between the position of the transponder 408 and the first bright point of twelve bright points is also calculated. The actual distance of the transponder 408 is calculated using the one or more frequency bands of the distress signal receiver 540 and the calculated transponder deviation value.

FIG. 9 illustrates a schematic timing chart 900 of the distress signal received from transponder 408, until the radar reception signal is obtained by the radar system 418. The distress signal from the transponder 408 appears as twelve bright points (dots) with a fixed distance interval (e.g., 0.6 NM) in the distance direction. The position of the first bright point is detected from this characteristic pattern. It may also be possible to detect the position of the first bright point of the transponder 408 from the sweep frequency characteristic (i.e. 300 [MHz] / 7.5 [μs]). The exact distance of the transponder position is calculated from the distance of the first bright point position and the information of the radar reception band.

The amount of deviation between the transponder position and the first bright point is calculated from the distance of the first bright point of the transponder signal and the information of the radar reception band. For example, if the center of the radar reception band is 9,250 MHz, it takes approximately 0.4 [μs] (±0.1 [μs]) to sweep from 9,200 [MHz] to 9,500 [MHz] of the transponder response wave (distress signal) and approximately 7.5 [μs] (±0.1 [μs]) to sweep from 9,500 [MHz] to 9,200 [MHz], which indicates that the transponder position is 997.5 [m] ahead of (i.e., closer than) the first bright point.
DEVIATION BETWEEN THE SART POSITION AND THE FIRST BRIGHT POINT: TIME:

0.4 [μs]+(9,500 [MHz]−9,250 [MHz])/(300 [MHz]/7.5 [μs])=6.65 [μs]
TRANSPONDER POSITION:

6.65 [μs]×150 [m/μs]=997.5 [m]

The frequency sweep band of the distress signal of the transponder 408 may be 9,200 to 9,500 MHz, and in one transmission, twelve pulses of which frequencies are swept in the sawtooth form may continuously be transmitted (A timing diagram (A) of FIG. 9).

A timing diagram (B) of FIG. 9 shows the amplitude of the distress signal received by the distress signal receiver 540 at the frequency band of 9,250 MHz.

A timing diagram (C) of FIG. 9 shows a frequency change amount of the distress signal received by the distress signal receiver 540 at the frequency band of 9,250 MHz.

A timing diagram (D) of FIG. 9 shows a transponder detection flag frequency change amount of the distress signal received by the distress signal receiver 540 at the frequency band of 9,250 MHz.

A timing diagram (E) of FIG. 9 shows the distance of the bright points of the distress signal received from the transponder 408. A distance 902 represents the distance of a first bright point from the transponder 408, a distance 904 represents the distance of a second bright point from the transponder 408, a distance 906 represents the distance of an eleventh bright point from the transponder 408 and a distance 908 represents the distance of a twelfth bright point from the transponder 408.

FIG. 10 illustrates a beam pattern 1000 of the antenna 516 of the radar system 418, in accordance with an embodiment of the present disclosure. The horizontal directivity of an antenna built into the transponder 408 is omnidirectional. A transponder azimuth detector 604 of the radar system 418 is configured to calculate the azimuth of the transponder 408 from a peak value of a distress signal at the same distance. As shown in FIG. 11, when the distress signal at the same distance is viewed in the azimuth, it is similar to the beam pattern 1002 of the radar antenna. Hence, this makes it difficult for the observer to view the exact location of the transponder 408 in the azimuth direction, specifically when the transponder 408 is near or close to the radar system 418 (for the rescue vessel 402). The transponder distance detector 602 of the radar system 418 calculates the amount of deviation between the position of the transponder 408 and the first bright point, based on the distance of the first bright point of the distress signal and the information of the radar reception band.

FIG. 11 illustrates a graphical representation 1100 of distance (r1, r2, . . . , rn) of the bright points from the transponder 408 along the azimuth (a1, a2, . . . , an), in accordance with an embodiment of the present disclosure. The peak value of each bright point in distress signal at the same distance is shown in FIG. 11.

The distance, azimuth, and signal level of each bright point of the transponder 408 stored in the memory 806 of the transponder distance detector 602 are retrieved. Each peak is obtained for the data series in the azimuth at the same distance. For example, if the first bright point of the transponder 408 is at the distance r1 and the azimuth a1, the data series in the azimuth at the distance r1 is D [r1] [a1], if the second bright point of the transponder 408 is at the distance r2 and the azimuth a2, the data series in the azimuth at the distance r2 is D [r2] [a2], and so on.

The data series D [r1] [a1], D [r2] [a2], . . . , D [rn] [an] in the azimuth (a1, a2, . . . , an) at the respective distance (r1, r2, . . . , rn) have a convex shape upward as shown in FIG. 11. Since the signal level in the direction of the transponder 408 is the highest, the azimuth of the transponder position can be obtained by calculating the peak of the data series D [r1] [a1] . . . D [r1] [an]. For greater accuracy, all twelve azimuths (angular) information obtained by performing the same processing from the first bright point to the twelfth bright point of the transponder 408 are averaged. The most-frequently appearing azimuth (angle) is used as the transponder azimuth (orientation/angle).

It should be noted that the transponder azimuth detector 604 of the radar system 418 is configured to obtain the peak value of each bright point at the same distance from the distance, azimuth, and signal level of each bright point stored in the memory 806. The transponder azimuth detector 604 obtains the azimuth of all bright points from the peak value of each bright point, and calculates the azimuth of the transponder 408 on the basis of the most frequently occurring azimuth from all bright points or the average of the azimuth calculated from all bright points.

FIG. 12 illustrates a representation of a display output 1200 on the radar screen 504 indicating the actual position of the transponder 408 by using the EBL and the VRM, in accordance with an embodiment of the present disclosure. The transponder position calculator 606 obtains the actual distance of the transponder 408 from the transponder distance detector 602. The transponder position calculator 606 also obtains the azimuth information of the transponder 408 from the transponder azimuth detector 604. The transponder position calculator 606 calculates the latitude and longitude of the transponder 408 based on the actual distance of the transponder 408 and the azimuth information of the transponder 408. The latitude and longitude of the rescue vessel 402 can be obtained from the GPS satellite. The latitude and longitude of the transponder 408 are calculated based at least on the latitude and longitude of the rescue vessel.

The display output 1200 with distance and azimuth (orientation) of the transponder position are displayed on the radar screen 504 with better visibility. For example, the display output 1200 shows a distress signal 1202 (the twelve bright points expanded in the azimuth angle A′) and a position 1204 of the transponder 408. A position 1206 represents the position of the rescue vessel 402. A marking 1208 indicates the actual position of the transponder 408, which is located ahead of (i.e., closer than) the first bright point 1210 by the calculated deviation. It should be noted that the first bright point 1210 is shown adjacent to the marking 1208. In the enlarged view, the first bright point 1210, and a second bright point 1212 along with marking 1208 indicating the actual position of the transponder 408 are displayed on the radar screen 504. The position of the transponder 408 can be displayed on the radar screen 504 by keeping a trail (wake) even if the distress signal disappears.

FIG. 13 illustrates a flow diagram of a method 1300 for detecting and calculating the actual position of the transponder 408, in accordance with an embodiment of the present disclosure. The various steps and/or operations of the flow diagram, and combinations of steps/operations in the flow diagram, may be implemented by, for example, hardware, firmware, a processor, circuitry, a system, an apparatus (such as the radar system 418), and/or the transponder distance detector 602 explained with reference to FIG. 6 and/or by a different device associated with the execution of software that includes one or more computer program instructions. The method 1300 starts at operation 1302.

At step 1302, the transponder position detector 538 of radar system 418 is configured to determine the position of the transponder 408. The determination of the position of the transponder 408 may include performing steps 1302a, 1302b, 1302c, 1302d, 1302e, and 1302f.

At step 1302a, the transmitter 500 generates an electromagnetic signal.

At step 1302b, the circulator 542 connects the antenna 516 with the transmitter, for transmitting the electromagnetic signal around the vessel.

At step 1302c, the circulator 542 connects the antenna 516 with the distress signal receiver 540, for receiving a distress signal from the transponder 408.

At step 1302d, the distress signal receiver 540, in response to the transmitted electromagnetic signal, filters the distress signal at one or more frequency bands received from the transponder 408 through the antenna. The distress signal generally includes twelve bright points and the adjacent bright points are separated by a fixed distance.

At step 1302e, the controller 600 operatively connects the transmitter 500 and the distress signal receiver 540 and controls at least one operation of the transmitter 500 or the distress signal receiver 540.

At step 1302f, the processing circuitry 536, including the transponder distance detector 602, calculates the actual distance of the transponder 408 by operatively connecting the controller 600 and the transponder distance detector 602.

At step 1304, the display 507 displays on the radar screen 504, the position of the transponder 408 determined by the transponder position detector 538.

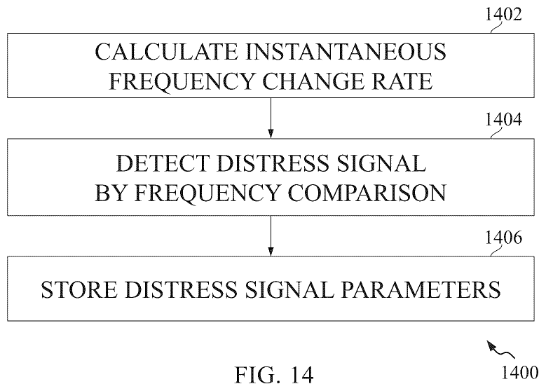

FIG. 14 illustrates a flow diagram of a method 1400 for detecting the distress signal from the transponder 408, in accordance with an embodiment of the present disclosure. The various steps and/or operations of the flow diagram, and combinations of steps/operations in the flow diagram, may be implemented by, for example, hardware, firmware, a processor, circuitry, a system, an apparatus (such as the radar system 418), and/or the transponder distance detector 602 explained with reference to FIG. 6 and/or by a different device associated with the execution of software that includes one or more computer program instructions. The method 1400 starts at operation 1402.

At step 1402, the instantaneous frequency change rate calculator 802 receives a signal from one or more objects (including distress vessel 406) and calculates a change rate of an instantaneous frequency of the received signal.

At step 1404, the method 1400 includes detecting, by a distress signal determiner 804, the distress signal from the transponder 408, by comparing the change rate of the instantaneous frequency of the received signal with a reference frequency sweep rate of the distress signal. If the change rate of the instantaneous frequency of the received signal is within a threshold of the reference rate of the distress signal, the distress signal determiner 804 determines that the received signal is the distress signal from the transponder 408.

At step 1406, the method 1400 includes storing, by the memory 806, at least the reference frequency sweep rate of the distress signal, the distance of each bright point, an azimuth of each bright point, and a signal level of each bright point, upon detecting the distress signal from the transponder 408 by the transponder distance detector 602.

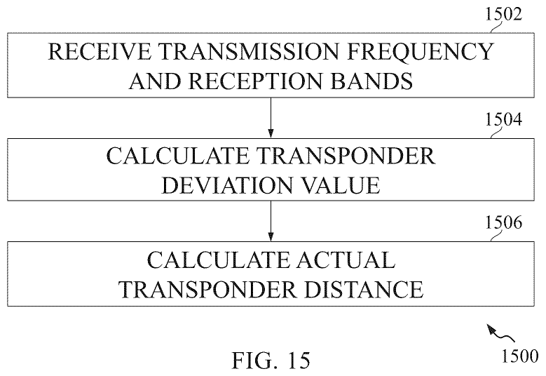

FIG. 15 illustrates a flow diagram of a method 1500 for calculating the actual distance of the transponder 408 by the transponder distance detector 602, in accordance with an embodiment of the present disclosure. The various steps and/or operations of the flow diagram, and combinations of steps/operations in the flow diagram, may be implemented by, for example, hardware, firmware, a processor, circuitry, a system, an apparatus (such as the radar system 418), and/or a transponder distance detector 602 explained with reference to FIG. 6 and/or by a different device associated with the execution of software that includes one or more computer program instructions. The method 1500 starts at operation 1502.

At step 1502, the method 1500 includes receiving, by the distress signal determiner 804 of the transponder distance detector 602, at least one of transmission frequency from the transmitter 500 and the one or more frequency bands from the distress signal receiver 540.

At step 1504, the method 1500 includes calculating, by the distress signal determiner 804 of the transponder distance detector 602, a transponder deviation value between the position of the transponder 408 and the first bright point of twelve bright points.

At step 1506, the method 1500 includes calculating, by the distress signal determiner 804 of the transponder distance detector 602, the actual distance of the transponder 408 using the one or more frequency bands of the distress signal receiver 540 and the calculated transponder deviation value.

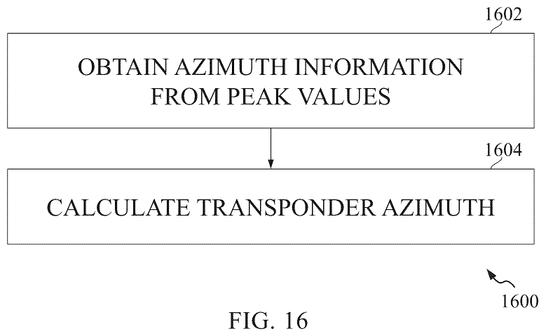

FIG. 16 illustrates a flow diagram of a method 1600 for calculating an azimuth of the transponder 408, in accordance with an embodiment of the present disclosure. The various steps and/or operations of the flow diagram, and combinations of steps/operations in the flow diagram, may be implemented by, for example, hardware, firmware, a processor, circuitry, a system, an apparatus (such as the radar system 418), and/or a transponder azimuth detector 604 explained with reference to FIG. 6 and/or by a different device associated with the execution of software that includes one or more computer program instructions. The method 1600 starts at operation 1602.

At step 1602, the method 1600 includes obtaining, by the transponder azimuth detector 604, azimuth information of twelve bright points from the peak value of each bright point, where the signal level of each bright point in azimuth is the peak value at the same distance from the distance, the azimuth, and the signal level of each bright point stored in the memory (806).

At step 1604, the method 1600 includes calculating, by the transponder azimuth detector 604, azimuth of transponder based at least on averaged value of obtained azimuth information of twelve bright points or most frequently occurring azimuth information from twelve bright points.

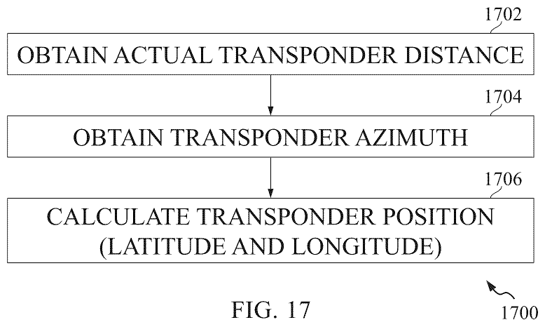

FIG. 17 illustrates a flow diagram of a method 1700 for calculating the actual position of the transponder based on the azimuth information, in accordance with an embodiment of the present disclosure. The various steps and/or operations of the flow diagram, and combinations of steps/operations in the flow diagram, may be implemented by, for example, hardware, firmware, a processor, circuitry, a system, an apparatus (such as the radar system 418), and/or the transponder position calculator 606 explained with reference to FIG. 6 and/or by a different device associated with the execution of software that includes one or more computer program instructions. The method 1700 starts at operation 1702.

At step 1702, the method 1700 includes obtaining, by the transponder position calculator 606, the actual distance of the transponder 408 from the transponder distance detector 602.

At step 1704, the method 1700 includes obtaining, by the transponder azimuth detector 604, the azimuth of transponder 408 from transponder azimuth detector 604.

At step 1706, the method 1700 includes calculating, by the transponder position calculator 606, the latitude and longitude of the transponder 408 based at least on the latitude and longitude of the vessel, the actual distance of the transponder 408, and the azimuth of the transponder 408. The user interface 506 is used to accept a setting of at least an Electronic Bearing Line (EBL) representing an azimuth from the vessel (e.g., the rescue vessel 402) to the transponder 408 and a Variable Range Marker (VRM) representing the actual distance from the vessel to the transponder 408. The latitude and longitude of the transponder 408 along with a marking on the radar screen 504 are displayed, by the display 507, on the radar screen 504. Thus, the present disclosure calculates the actual position of the transponder 408 by taking into account the deviation between the position of the transponder 408 and the first bright point of the distress signal.

The methods with reference to FIGS. 12 to 17, or one or more operations of the radar system 418 may be implemented using software including computer-executable instructions or machine-readable instructions stored on one or more computer-readable media (e.g., non-transitory computer-readable media, such as one or more optical media discs, volatile memory components (e.g., Dynamic Random Access Memory (DRAM) or Static Random Access Memory (SRAM)), or non-volatile memory or storage components (e.g., hard drives or solid-state non-volatile memory components, such as Flash memory components)) and executed on a computer (e.g., any suitable computer, such as a Multi-Function Device (MFD), Multi-Function Device Black Box (MFD-BB), a navigation device, a chart plotter, Electronic Chart Display And Information System (ECDIS), a laptop computer, netbook, Webbook, tablet computing device, smartphone, or other mobile computing devices). Such software may be executed, for example, on a single local computer or in a network environment (e.g., via the Internet, a wide-area network, a local-area network, a remote web-based server, a client-server network (such as a cloud computing network), or other such networks) using one or more network computers. Additionally, any of the intermediate or final data created and used during the implementation of the disclosed methods or systems may also be stored on one or more computer-readable media (e.g., non-transitory computer-readable media) and are considered to be within the scope of the disclosed technology. Furthermore, any of the software-based embodiments may be uploaded, downloaded, or remotely accessed through a suitable communication means. Such suitable communication means include, for example, the Internet, the World Wide Web (WWW), an intranet, software applications, cable (including fiber optic cable), magnetic communications, source communications (including Radio Frequency (RF), microwave, and infrared communications), electronic communications, or other such communication means.

Although the present disclosure has been described with reference to specific exemplary embodiments, it is noted that various modifications and changes may be made to these embodiments without departing from the broad spirit and scope of the present disclosure. For example, the various operations, blocks, etc., described herein may be enabled and operated using hardware circuitry (for example, Complementary Metal-Oxide Semiconductor (CMOS) based logic circuitry), firmware, software, and/or any combination of hardware, firmware, and/or software (for example, embodied in a machine-readable medium). For example, the apparatuses and methods may be embodied using transistors, logic gates, and electrical circuits (for example, Application-Specific Integrated Circuit (ASIC) circuitry and/or in Digital Signal Processor (DSP) circuitry).

Particularly, the processing circuitry 536 among other components of the radar system 418 may be enabled using software and/or using transistors, logic gates, and electrical circuits (for example, integrated circuit circuitry such as ASIC circuitry). Various embodiments of the present disclosure may include one or more computer programs stored or otherwise embodied on a computer-readable medium, wherein the computer programs are configured to cause a processor or the computer to perform one or more operations. A computer-readable medium storing, embodying, or encoded with a computer program, or similar language, may be embodied as a tangible data storage device storing one or more software programs that are configured to cause a processor or computer to perform one or more operations. Such operations may be, for example, any of the steps or operations described herein. In some embodiments, the computer programs may be stored and provided to a computer using any type of non-transitory computer-readable media. Non-transitory computer-readable media include any type of tangible storage media. Examples of non-transitory computer-readable media include magnetic storage media (such as floppy disks, magnetic tapes, hard disk drives, etc.), optical magnetic storage media (e.g., magneto-optical disks), Compact Disc Read-Only Memory (CD-ROM), Compact Disc Recordable (CD-R), Compact Disc Rewritable (CD-R/W), Digital Versatile Disc (DVD), BD (BLU-RAY(R) Disc), and semiconductor memories (such as mask ROM, programmable ROM (PROM), Erasable PROM (EPROM), flash memory, Random Access Memory (RAM), etc.). Additionally, a tangible data storage device may be embodied as one or more volatile memory devices, one or more non-volatile memory devices, and/or a combination of one or more volatile memory devices and non-volatile memory devices. In some embodiments, the computer programs may be provided to a computer using any type of transitory computer-readable media. Examples of transitory computer-readable media include electric signals, optical signals, and source waves. Transitory computer-readable media can provide the program to a computer via a wired communication line (e.g., electric wires, and optical fibers) or a wireless communication line.

Thus, the processing circuitry 536 allows no degradation and disappearance of echo trail images when the display range is changed by the user. Further, the present disclosure allows the observer to easily judge the situation of the target object immediately after the display range is changed.

Various embodiments of the disclosure, as discussed above, may be practiced with steps and/or operations in a different order, and/or with hardware elements in configurations, which are different than those which are disclosed. Therefore, although the disclosure has been described based upon these exemplary embodiments, it is noted that certain modifications, variations, and alternative constructions may be apparent and well within the scope of the disclosure.

### Terminology

It is to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

All of the processes described herein may be embodied in, and fully automated via, software code modules executed by a computing system that includes one or more computers or processors. The code modules may be stored in any type of non-transitory computer-readable medium or other computer storage device. Some or all the methods may be embodied in specialized computer hardware.

Many other variations than those described herein will be apparent from this disclosure. For example, depending on the embodiment, certain acts, events, or functions of any of the algorithms described herein can be performed in a different sequence, can be added, merged, or left out altogether (e.g., not all described acts or events are necessary for the practice of the algorithms). Moreover, in certain embodiments, acts or events can be performed concurrently, e.g., through multi-threaded processing, interrupt processing, or multiple processors or processor cores or on other parallel architectures, rather than sequentially. In addition, different tasks or processes can be performed by different machines and/or computing systems that can function together.

The various illustrative logical blocks and modules described in connection with the embodiment disclosed herein can be implemented or performed by a machine, such as a processor. A processor can be a microprocessor, but in the alternative, the processor can be a controller, microcontroller, or state machine, combinations of the same, or the like. A processor can include electrical circuitry configured to process computer-executable instructions. In another embodiment, a processor includes an application specific integrated circuit (ASIC), a field programmable gate array (FPGA) or other programmable device that performs logic operations without processing computer-executable instructions. A processor can also be implemented as a combination of computing devices, e.g., a combination of a digital signal processor (DSP) and a microprocessor, a plurality of microprocessors, one or more microprocessors in conjunction with a DSP core, or any other such configuration. Although described herein primarily with respect to digital technology, a processor may also include primarily analog components. For example, some or all of the signal processing algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

Conditional language such as, among others, “can,” “could,” “might,” or “may,” unless specifically stated otherwise, are otherwise understood within the context as used in general to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Any process descriptions, elements or blocks in the flow diagrams described herein and/or depicted in the attached figures should be understood as potentially representing modules, segments, or portions of code which include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C. The same holds true for the use of definite articles used to introduce embodiment recitations. In addition, even if a specific number of an introduced embodiment recitation is explicitly recited, those skilled in the art will recognize that such recitation should typically be interpreted to mean at least the recited number (e.g., the bare recitation of “two recitations,” without other modifiers, typically means at least two recitations, or two or more recitations).

It will be understood by those within the art that, in general, terms used herein, are generally intended as “open” terms (e.g., the term “including” should be interpreted as “including but not limited to,” the term “having” should be interpreted as “having at least,” the term “includes” should be interpreted as “includes but is not limited to,” etc.).

For expository purposes, the term “horizontal” as used herein is defined as a plane parallel to the plane or surface of the floor of the area in which the system being described is used or the method being described is performed, regardless of its orientation. The term “floor” can be interchanged with the term “ground” or “water surface.” The term “vertical” refers to a direction perpendicular to the horizontal as just defined. Terms such as “above,” “below,” “bottom,” “top,” “side,” “higher,” “lower,” “upper,” “over,” and “under,” are defined with respect to the horizontal plane.

As used herein, the terms “attached,” “connected,” “mated,” and other such relational terms should be construed, unless otherwise noted, to include removable, movable, fixed, adjustable, and/or releasable connections or attachments. The connections/attachments can include direct connections and/or connections having intermediate structure between the two components discussed. Unless otherwise explicitly stated, numbers preceded by a term such as “approximately,” “about,” and “substantially” as used herein include the recited numbers, and also represent an amount close to the stated amount that still performs a desired function or achieves a desired result.

For example, unless otherwise explicitly stated, the terms “approximately,” “about,” and “substantially” may refer to an amount that is within less than 10% of the stated amount. Features of embodiments disclosed herein preceded by a term such as “approximately,” “about,” and “substantially” as used herein represent the feature with some variability that still performs a desired function or achieves a desired result for that feature.

It should be emphasized that many variations and modifications may be made to the above-described embodiments, the elements of which are to be understood as being among other acceptable examples. All such modifications and variations are intended to be included herein within the scope of this disclosure and protected by the following claims.

What is claimed is:

1. A radar system for calculating a position of a transponder, comprising:
a transmitter configured to generate an electromagnetic signal;
an antenna configured to transmit and receive the electromagnetic signal;
a distress signal receiver configured:
to receive signals from one or more target objects in response to the transmitted electromagnetic signal, and
to filter a distress signal, representing twelve bright points on the radar screen with adjacent bright points being separated by a fixed distance, at one or more frequency bands received from the transponder through the antenna;
a circulator configured:
to connect the antenna with the transmitter, and
to connect the antenna with the distress signal receiver to receive the distress signal; and
processing circuitry, operatively connected to the transmitter and the distress signal receiver, configured:
to control at least one operation of the transmitter or the distress signal receiver; and
to calculate an actual distance of the transponder.

2. The radar system of claim 1, wherein:
the processing circuitry is further configured:
to calculate a change rate of an instantaneous frequency of the signals received from one or more target objects; and
to detect the distress signal from the transponder by comparing the change rate of the instantaneous frequency of the signals received from one or more target objects with a reference frequency sweep rate of the distress signal.

3. The radar system of claim 2, wherein:
the processing circuitry is further configured:
to store at least the reference frequency sweep rate of the distress signal, the distance of each bright point, azimuth information of each bright point, and a signal level of each bright point, upon detecting the distress signal from the transponder.

4. The radar system of claim 3, wherein:
the processing circuitry is further configured:
to receive at least one of transmission frequency from the transmitter and the one or more frequency bands from the distress signal receiver;
to calculate a transponder deviation value between the position of the transponder and the first bright point of twelve bright points; and
to calculate the actual distance of the transponder using the one or more frequency bands of the distress signal receiver and the calculated transponder deviation value.

5. The radar system of claim 4, wherein:
the processing circuitry is further configured:
to obtain the azimuth information of the distress signal, having the twelve bright points, based on peak values of respective bright points, wherein,
for each bright point, the peak is determined in the azimuth direction at a given distance using the distance, azimuth, and signal level of each bright point; and
to calculate the azimuth of the transponder based at least on:
an averaged value of the obtained azimuth information of the twelve bright points; or
the most frequently occurring azimuth information from the twelve bright points.

6. The radar system of claim 5, wherein
the processing circuitry is further configured:
to calculate the actual distance of the transponder;
to calculate the azimuth of the transponder; and
to calculate a latitude and longitude of the transponder based at least on the latitude and longitude of the vessel, the actual distance of the transponder, and the azimuth of the transponder.

7. The radar system of claim 6, further comprising:
a user interface configured to accept a setting of at least an Electronic Bearing Line (EBL) representing an azimuth from the vessel to the transponder and a Variable Range Marker (VRM) representing the actual distance from the vessel to the transponder.

8. The radar system of claim 1, further comprising:
a display configured to display, on the radar screen, the position of the transponder determined by the processing circuitry.

9. The radar system of claim 8, wherein:
the display is further configured to display the latitude and longitude of the transponder along with a marking on the radar screen.

10. The radar system of claim 2, further comprising:
a display configured to display, on the radar screen, the position of the transponder determined by the processing circuitry.

11. The radar system of claim 10, wherein:
the display is further configured to display the latitude and longitude of the transponder along with a marking on the radar screen.

12. The radar system of claim 3, further comprising:
a display configured to display, on the radar screen, the position of the transponder determined by the processing circuitry.

13. The radar system of claim 12, wherein:
the display is further configured to display the latitude and longitude of the transponder along with a marking on the radar screen.

14. The radar system of claim 4, further comprising:
a display configured to display, on the radar screen, the position of the transponder determined by the processing circuitry.

15. The radar system of claim 14, wherein:
the display is further configured to display the latitude and longitude of the transponder along with a marking on the radar screen.

16. The radar system of claim 5, further comprising:
a display configured to display, on the radar screen, the position of the transponder determined by the processing circuitry.

17. The radar system of claim 16, wherein:
the display is further configured to display the latitude and longitude of the transponder along with a marking on the radar screen.

18. A method for calculating a position of a transponder, comprising:
generating an electromagnetic signal;
transmitting and receiving the electromagnetic signal;
receiving signals from one or more target objects in response to the transmitted electromagnetic signal, and
filtering a distress signal, representing twelve bright points on the radar screen with adjacent bright points being separated by a fixed distance, at one or more frequency bands;
calculating an actual distance of the transponder.

19. A non-transitory computer-readable medium having stored thereon computer-executable
instructions which, when executed by processing circuitry, cause the processing circuitry to execute processing comprising:
generating an electromagnetic signal;
transmitting and receiving the electromagnetic signal;
receiving signals from one or more target objects in response to the transmitted electromagnetic signal, and
filtering a distress signal, representing twelve bright points on the radar screen with adjacent bright points being separated by a fixed distance, at one or more frequency bands;
calculating an actual distance of the transponder.
